(19) United States
(12) Patent Application Publication
(10) Pub. No.: US 2018/0032933 A1
(43) Pub. Date: Feb. 1, 2018

(54) ADAPTIVE RESOURCE ALLOCATION

(71) Applicant: Accenture Global Solutions Limited, Dublin (IE)

(72) Inventors: Gregory Guthridge, Dublin (IE); John Austin, Attleboro, MA (US); Carson Wong, Dublin (IE)

(21) Appl. No.: 15/223,569

(22) Filed: Jul. 29, 2016

(51) Int. Cl. G06Q 10/06; G06N 99/00

(52) U.S. Cl. CPC G06Q 10/06313; G06N 99/005

(57) ABSTRACT

Computerized methods and systems, including computer programs encoded on a computer storage medium, may adaptively allocate resources within an enterprise. For example, a computing system may obtain data identifying an element of work. The computing system may assign the work element to a work category, establish a priority for resolving the work element within the assigned work category, and dynamically allocate the prioritized work element to an agent of the enterprise having availability to resolve the work element and having skill sets consistent with the work element. The computing system may also monitor the agent's performance while the agent applies or implements resolution processes via a corresponding agent system, and to provide, in real-time, data that characterizes the agent's performance in terms of key performance indicators to systems of the agent and other individuals across the enterprise.

### FIELD

This specification describes technologies related to enterprise resource management.

### BACKGROUND

Modern enterprises expend significant time, energy, and funds to develop and implement operations that process and resolve inquiries and requests received from various customers.

### SUMMARY

This specification describes computerized processes that identify incoming work elements received across multiple communications channels of an enterprise, and that process and resolve these incoming work elements within a single computational platform. In this specification, a work element is data that represents a request or inquiry for processing by one or more agents of an enterprise. The enterprise can be a business, a governmental, or a regulatory entity that provides goods or services to customers. For example, the enterprise may include an electrical utility that provides electrical power to residential and commercial customers and that invoices these customers on the basis of their consumption of electricity, and a work element can represent an inquiry from a residential or commercial customer regarding an outstanding balance invoiced during a prior billing cycle.

The computing system may leverage combinations of rules-based and machine learning techniques to assign the at least one work element to predetermined and/or adaptively established categories of work, to establish a priority for resolving the at least one work element within the assigned work categories, and further, to dynamically allocate the work elements to agents of the enterprise having availability to resolve the work elements and having skill sets consistent with the work elements.

The computing system may also detect when an agent initiates processing of a work element (e.g., “picks up” the work element), monitor the agent's performance while the agent applies or implements resolution processes via a corresponding agent system, and to provide, in real-time, data that characterizes the agent's performance in terms of key performance indicators to systems of both the agent and other individuals across the enterprise. In certain aspects, the agent system may present, in real-time, a graphical representation of these example performance indicators, and other key performance indicators, to the agent within a graphical user interface (e.g., a dashboard), and may modify, in real-time, the graphical representation to reflect the continuing performance of the agent or the agent's peers. The computing system may provide these and other key performance indicators to other employees of the enterprise (e.g., the agent's managers, etc.), who may monitor the agent's performance and implement directed training programs across the enterprise.

In some implementations, an apparatus may include at least one processor and a memory storing executable instructions that, when executed by the at least one processor, causes the at least one processor to perform the step of obtaining first data identifying a first work element. In one aspect, the first work element may being associated with a user and being characterized by a target resolution time. Based on the obtained first data, the at least one processor may also perform the steps of assigning the first work element to a work category and establishing a priority for resolving the first work element within the assigned work category. The at least one processor may also perform the steps of accessing second data identifying a plurality of agents, which may be associated with corresponding amounts of unallocated time, and identifying a corresponding one of the agents capable of resolving the first work element in accordance with the established priority. In certain aspects, the amount of unallocated time associated with the corresponding agent may be equivalent to or greater than the target resolution time. The at least one processor may also perform the step of transmitting information associated with the first work element to a computing system of the corresponding agent. The computing system may, for instance, be configured to present at least a portion of the transmitted information to the corresponding agent through a graphical user interface.

In certain aspects, the step of obtaining includes accessing third data identifying a plurality of queued elements of work, establishing that one of the data records corresponds to the first work element, and obtaining at least a portion of the first data from the corresponding data record. In some instances, the third data comprising data records may correspond to the queued work elements, the data records may identify characteristics of each of the queued work elements, and the first data portion may include at least one of the characteristics of the first work element.

In other aspects, the step of obtaining also include receiving at least a portion of the first data from at least one of a device operated by the user or an additional computing system associated with an enterprise. The at least one processor may perform the additional steps of storing the first data portion within at least one data record of data repository, accessing workflow queue data, establishing, within the workflow queue data, an additional entry corresponding to the first work element, and associating the established additional entry with the at least one data record of the data repository. In certain instances, the workflow queue data may include a plurality of entries associated with queued work elements.

Additionally, in some aspects, the step of assigning may include identifying a plurality of candidate work categories associated with the first work element, determining that a corresponding one of the candidate work categories is consistent with at least a portion of the first data, and assigning the first work element to the corresponding one of the candidate work categories. In other aspects, the step of assigning may include obtaining third data identifying a plurality of second elements of work, which may be assigned to corresponding ones of a plurality of work categories, applying a machine-learning algorithm to at least a portion of the obtained first and third data, and assigning the first work element to the work category based on an outcome of the applied machine-learning algorithm. In further aspects, the first data may identify a deadline associated with the first work element, and the step of establishing may include establishing the priority for the first work element in accordance with the identified deadline. In additional aspects, the step of d identifying may also include

In certain aspects, the step of identifying may include identifying, among the plurality of agents, candidate agents having an amount of unallocated time that exceeds the target resolution time, determining whether skills sets of a first subset of the candidate agents include at least one primary skill associated with the first work element, and when the skills sets of the first subset of the candidate agents are determined to include the at least one primary skill, select the corresponding agent from the first subset of the candidate agents. The step of identifying may, in additional aspects, also include when the skills sets of the first subset of the candidate agents are determined not to include the at least one primary skill, determining whether skill sets of a second subject of the candidate agents include at least one secondary skill associated with the first work element, and when the skills sets of the second subset of the candidate agents are determined to include the at least one secondary skill, selecting the corresponding agent from the second subset of the candidate agents. Further, when the when the skills sets of the second subset of the candidate agents are determined to not include the at least one secondary skill, the step of identifying may also include transmitting an allocation request identifying the first work element to devices associated with the candidate agents. The candidate agent devices may, for example, be configured to present, through a graphical user interface, one or more interface elements that prompt the candidate agents to provide input selecting the first data element for resolution. The step of identifying may also include receiving data indicating a selection of the first work element by a corresponding one of the candidate agents, and assigning the first work element to the corresponding one of the candidate agents for resolution.

Further, in certain aspects, the step of identifying may include obtaining third data identifying a plurality of resolved work elements. In some aspects, the resolved work elements may be previously allocated to one or more agents, and the agents may have corresponding skill sets. The step of identifying may also include applying a machine-learning algorithm to at least a portion of the obtained first and third data, and identifying the corresponding agent capable of resolving the first work element based on an outcome of the applied machine-learning algorithm.

Additionally, and in one aspect, the at least one processor may perform the steps of, in response to the transmitted information, receiving, from the computer system, third data characterizing a resolution process applied to the first work element by the corresponding agent, generating, based on at least a portion of the received third data, at least one metric indicative of a performance of the corresponding agent during the applied resolution process; and, and transmitting information associated with the one or more generated metrics to the computing system, the computing system being configured to present a graphical representation of the at least one generated metric to the corresponding agent within a portion of the graphical user interface.

In other aspects, the first work element may include an inquiry received from a device of the user, and the at least one processor may also perform the steps of receiving a response to the inquiry from the computing system, identifying a communication channel associated with at least one of the user or the received response, and transmitting the received response to the user device using the identified communications channel. The response may, in certain instances, be generated by the computing system based on at least one template, and the response may include an electronic document, an email message, a text message, or textual data.

Further, and in additional aspects, the user may correspond to a customer of an enterprise, and the first work element may include at least one of a customer inquiry or a billing exception. The first data portion may, for example, include at least one of data identifying the customer, data identifying the enterprise, data identifying one or more accounts of the customer, or data characterizing that at least one customer inquiry or billing exception. The first work element may include at least one of a customer inquiry or a billing exception, and the first data portion may include data characterizing the at least one customer inquiry or billing exception. In further aspects, the step of obtaining may include obtaining message data that includes the first data. The message data may correspond to at least one of an email message or a text message, and the message data may have a corresponding message format. The step of obtaining may also include establishing an inconsistency between the message format of the obtained message data and a predetermined message format associated with the first work element, and in response to the established inconsistency, modifying at least a portion of the obtained message data in accordance with the predetermined data format.

In other implementations, an apparatus includes at least one processor and a memory storing executable instructions that, when executed by the at least one processor, causes the at least one processor to perform the step of identifying an agent capable of resolving a work element. The identified agent may, for example, be associated with an amount of unallocated time that is equivalent to or in excess of a target resolution time of the work element. The at least one processor may perform the steps of transmitting first data identifying first work element to a computing system associated with the agent, and in response to the transmitted data, receiving, from the computer system, second data characterizing a resolution process applied to the work element by the agent. The computing system may, in some instances, be configured to present at least a portion of the transmitted information to the agent through a graphical user interface. The at least one processor may also perform the steps of generating, based on at least a portion of the second data, at least one metric indicative of a performance of the agent during the applied resolution process, and transmitting third data identifying the one or more generated metrics to the computing system. The computing system may be configured to present a graphical representation of the one or more generated metrics to the agent within a portion of the graphical user interface.

In some aspects, the third data may include first and second time stamps. The first time stamp may correspond to an initiation of the resolution process, and the second time stamp may correspond to a completion of the resolution process. The at least one processor may also perform the step of determining an actual resolution time for the first work element based on a difference between the first and second time stamps, in certain instances, the at least one metric may include the actual resolution time. In further aspects, the at least one processor may perform the step of transmitting the third data to at least one of a computing system associated with a manager of the agent or a computing system associated with at least one additional agent in real-time.

In further implementations, corresponding computer-implemented methods and computer programs may be configured to perform those steps performed by the example apparatus described above. One or more computer programs can be so configured by virtue of having instructions that, when executed by device, cause the device to perform the actions.

These techniques, and those described below, may be used instead of or in addition to techniques that, in response to requests received from computing devices of available agents, “pull” data identifying unallocated work elements from a centralized repository and assign these work elements to the available agents for resolution, which may result in an inconsistent allocation of enterprise resources that increases labor costs and fragments a customer's experience. Certain implementations of these techniques, and those described below, may also realize one or more of the following advantages. For example, a computing system may communicate with, and allocate tasks to, many hundreds or thousands of communications devices operated by geographically dispersed agents of the enterprise. By passively monitoring a performance and an availability of these agents, the computing system may dynamically allocate incoming work elements to available agents upon receipt from corresponding devices, and may automatically “push” data identifying the allocated work elements to the corresponding devices without input from the agents. In certain implementations, the dynamic allocation of incoming work requests to the available agents and the automatic provision of data identifying the allocated work requests to the corresponding devices may reduce a volume of network traffic between the computing system and the corresponding devices, as the computing system need not allocate tasks in response to agent requests, and may render more efficient the operation of the computer system, as the computer system need not perform operations to parse the agent requests and pull data identifying outstanding work elements from a central repository prior to allocation.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a diagram of an environment in which a workflow management system adaptively allocates incoming inquiries to available agents.

FIG. 2A is a diagram of an example graphical user interface.

FIG. 2B is a block diagram illustrating portions of stored case and agent data.

FIG. 2C is a diagram of an example graphical user interface.

FIGS. 3 and 4 are flowcharts of example processes for adaptively allocating incoming inquiries to available agents.

FIG. 5 is a diagram of an example computing system that may perform one or more of the disclosed computer-implemented processes.

Like reference numbers and designations in the various drawings indicate like elements.

### DETAILED DESCRIPTION

This specification describes a system that identifies incoming elements of work received across multiple communications channels, and to manage and resolve these incoming work elements within a single computing platform that adaptively and automatically categorizes the incoming work elements, prioritizes the incoming work elements for resolution, and allocates prioritized work elements to available enterprise employees, e.g., agents, based on tracked agent performance data. In certain aspects, an element of work may represent a request or inquiry that, upon receipt by the enterprise, may be resolved by one or more agents of the enterprise through an application of appropriate resolution processing. Further, the enterprise may include a business, governmental, and/or regulatory entity that provides goods or services to customers, and that invoices these customers on the basis of their consumption of the provided goods or services

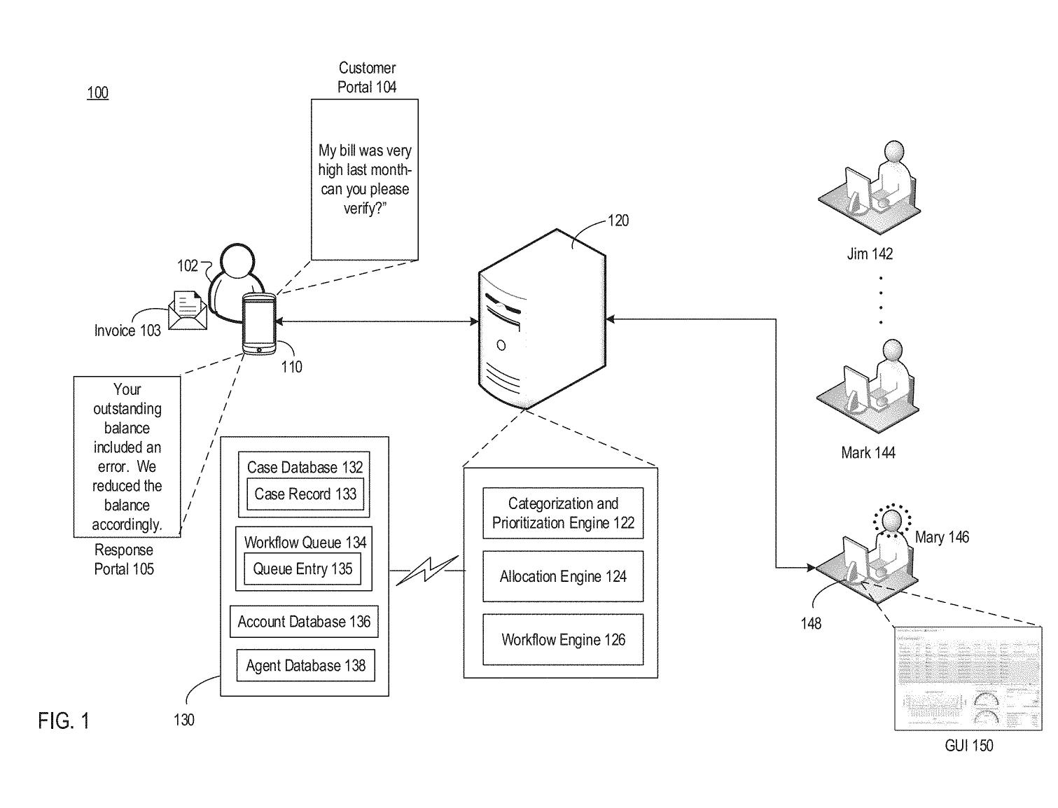

FIG. 1 illustrates an example system 100 that dynamically prioritizes and allocates for resolution incoming work elements across an enterprise, e.g., customer inquiries received by an electrical utility. The system 100 may, in some aspects, include a client device 110, a computing system 120, and a plurality of agent systems (e.g., agent system 148), which may be interconnected through any appropriate combination of communications networks, e.g., a wireless local area network (LAN), e.g., a “WiFi” network, a RF network, a Near Field Communication (NFC) network, a wireless Metropolitan Area Network (MAN) connecting multiple wireless LANs, and a wide area network (WAN), e.g., the Internet.

In reference to FIG. 1, client device 110 may be configured to receive input specifying an element of work, which may be packed into work-element data and transmitted across the communications network to computing system 120 for categorization, prioritization, and allocation using any of the processes described below. For example, the specified element of work may correspond to an invoice inquiry that requests clarification regarding an invoice issued by the enterprise during a prior billing cycle. The techniques described below are not limited to this example type of work element, and in other aspects, the example processes described below may be applied to any additional or alternate work element or type of work element that would appropriate to the enterprise.

For example, a user 102 of client device 110 may be a customer of the electrical utility, and may receive a monthly invoice 103 from the electrical utility that accounts for user 102's consumption of electricity (e.g., based on kilowatts of consumed electricity) during a prior month. As described above, user 102 may be a residential customer of the electrical utility, and invoice 103 may reflect user 102's consumption of electricity due to residential lighting, heating and air conditioning, and use of various appliances, such as hot-water heaters, ovens, and refrigerators. In other aspects, user 102 may be a business customer of the electrical utility, and invoice 103 may reflect the consumption of electricity by user 102's business over the prior month.

User 102 may review invoice 103, and may determine that the outstanding balance is higher than expected and inconsistent with prior monthly balances. Based on this determination, and prior to providing payment to the electrical utility, user 102 may elect to submit an invoice inquiry (e.g., an element of work) to the electrical utility that disputes the outstanding balance and requests clarification from the electrical utility. For instance, user 102 may access, via client device 110, a customer portal 104 provided by the electrical utility, e.g., a web page rendered for presentation by client device 110 and/or a graphical user interface generated by a mobile application executed by client device 110. In certain aspects, customer portal 104 may include one or more interface elements (e.g., pull-down menus and text boxes) that, upon presentation by client device 110, prompt user 102 to provide input identifying user 102, user 102's account with the electrical utility, and a nature of user 102's inquiry (e.g., a billing inquiry that disputes an inconsistent monthly balance and requests clarification).

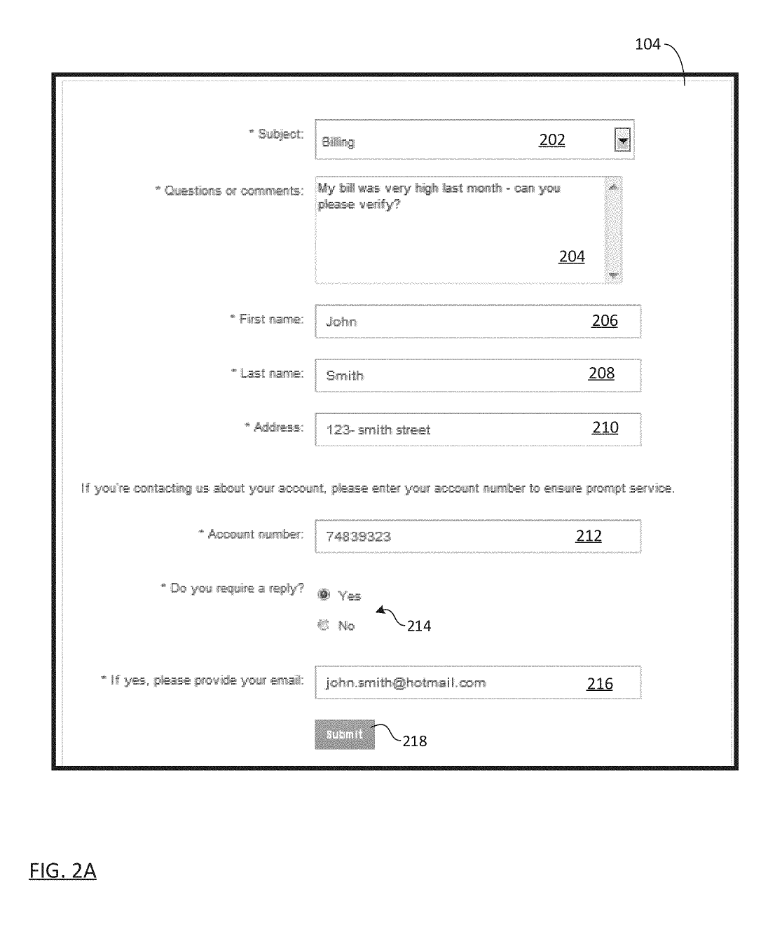

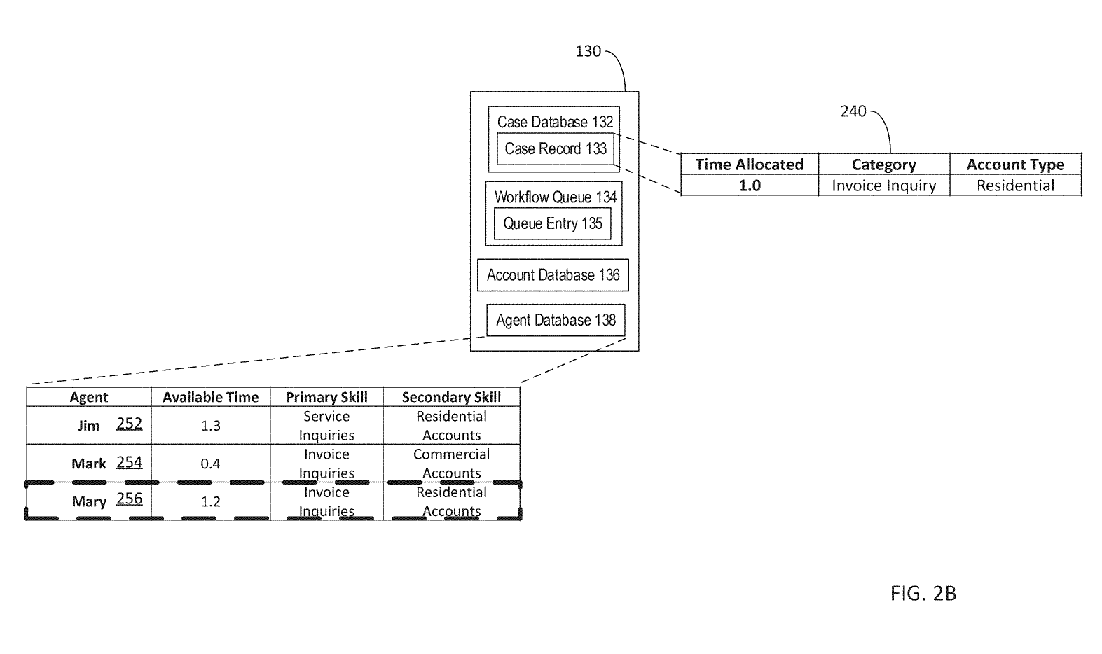

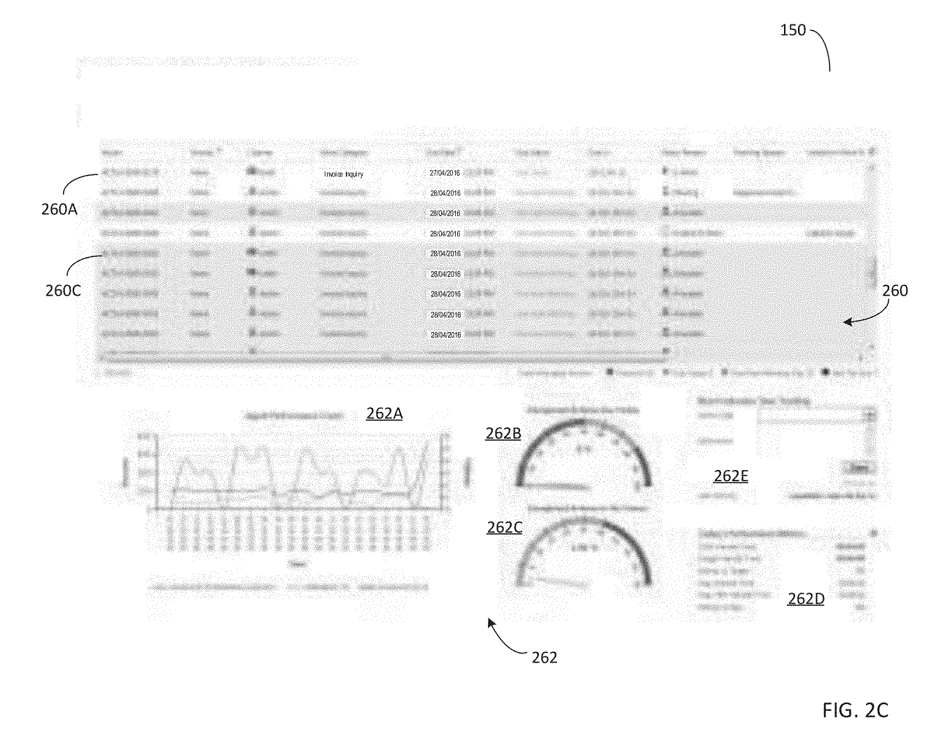

FIG. 2A illustrates an example layout of customer portal 104. For example, customer portal 104 includes an interface element 202, from which the user 102 can select, (e.g., from a pull down menu), an appropriate subject of the inquiry, e.g., “Billing,” and an interface element 204, through which the user 102 can provide textual input specifying questions or comments for resolution by the electrical utility (e.g., “My bill was very high last month—can you please verify?”). Customer portal 104 also includes interface elements 206, 208, and 210, through which the user 102 can specify a customer name (e.g., “John Smith”) and a customer address (e.g., “123 Smith Street”). Further, customer portal 104 also includes interface element 212, though which the user 102 can specify an account number associated with the inquiry (e.g., “74839323”). The customer portal 104 also includes interface elements 214 and 216, through the user 102 can request a reply and provide an email address for the reply (e.g., “john.smith@hotmail.com”). A customer portal need not be limited to these example interface elements of customer, account, and/or inquiry information. In other implementations, the customer portal 104 may include any additional or alternate interface elements that prompt user 102 to provide input specifying any additional or alternate information.

In some instances, user 102 may provide, to client device 110 as input to customer portal 104, inquiry data that identifies user 102, user 102's account with the electrical utility, and a nature of user 102's inquiry. Upon provision of the input, user 102 may touch, tap, click on, or otherwise activate interface element 218 of customer portal 104, and client device 110 may generate work-element data that includes the provided input, and may transmit the work-element data to computing system 120. For example, computing system 120 may receive the transmitted work-element data through one or more programmatic interfaces 121, e.g., an application programming interface (API) associated with and capable of exchanging data with web browsers and other application programs executed by client device 110. As described below, computing system 120 may process the work-element data to adaptively categorize and prioritize user 102's inquiry, and dynamically allocate user 102's inquiry to an available and capable agent for resolution.

In other implementations, user 102 may access, via client device 110, an interface associated with one or more email clients, which include, but are not limited to, a graphical user interface generated by an executed email application and a web page of a web-based email client generated by an executed web browser. User 102 may, in some aspects, provide portions of the inquiry data to client device 110 as inputs to the accessed interface, and the client device 110 may package the provided portions of the inquiry data into a corresponding email message, which may be transmitted to computing system 120 across any of the communications networks described above. The transmitted email message may include data that identifies user 102, user 102's account with the electrical utility, and a nature of user 102's inquiry, as described above, and may further include one or more attached electronic documents, such as scanned or captured images of monthly invoice 103 and other documents supporting user 102's invoice inquiry.

Computer system 120 may receive the transmitted email message, which may include the provided portions of the inquiry data and additionally or alternatively, the one or more attached electronic documents. The received email message may be associated with a particular, client-specific message format, which may not be fully compatible with a predetermined data format, such as a message format associated with the work-element data described above. In some aspects, and prior to processing user 102's inquiry, computing system 120 may perform operations that re-format the received email message in accordance with the predetermined data format. For example, computing system 120 may parse the received email message to extract the portions of the provided inquiry data, which specify user 102's inquiry, re-format the extracted portions of the inquiry data in accordance with the predetermined data format, and generate corresponding work-element data that includes the re-formatted inquiry data and additionally or alternatively, any attached electronic documents (or data identifying a storage location of the attached electronic document). As described below, computing system 120 may process the corresponding work-element data to adaptively categorize and prioritize user 102's inquiry, and dynamically allocate user 102's inquiry to an available and capable agent for resolution.

In further implementations, computing system 120 may receive data specifying user 102's inquiry across any additional or alternate electronic communications channel, such as those established by various messaging platforms (e.g., SMS-based or MMS-based text messaging), social media networks (e.g., Facebook™ or Twitter™) and by facsimile. Computing system 120 may, in some aspects, perform any of the processes described above to parse the received data, extract the portions of the inquiry data, re-format the extracted portions of the inquiry data in accordance with the predetermined data format, and generate corresponding work-element data that includes at least the re-formatted portions of the inquiry data for subsequent adaptive categorization, prioritization, and dynamic allocation, as described below.

Computer system 120 may parse the received or generated work-element data to obtain data identifying user 102 (e.g., user 102's name, address, telephone number, e-mail address, etc.), user 102's account with the electrical utility (e.g., the account number, etc.), and additionally or alternatively, a nature of user 102's inquiry (e.g., the subject of the inquiry and/or the textual input describing the inquiry). Computing system 120 may also establish, within case database 132, a new case record 133 associated with user 102's inquiry, and may populate the established case record with the obtained data identifying user 102, user 102's account, and/or user 102's inquiry.

Additionally, computing system 102 may populate case record 133 with additional data stored within data repository 130. For example, the inquiry data may specify user 102's account number, but may not specify an account type, a due date of an outstanding invoice, or a balance associated with that outstanding invoice. In some implementations, computing system 120 may obtain additional data identifying the account type, outstanding due date, and balance from account database 136, and may populate portions of case record 133 with the additional data.

In additional aspects, computing system 120 may add an entry 135 corresponding to the work element (e.g., user 102's inquiry) to a stored workflow queue (e.g., workflow queue 134), and may link the entry with populated case record 133 within case database 132. The entries of stored workflow queue 134 may, in some instances, be associated with corresponding work elements previously received by computing system 120, and these entries may be assigned corresponding identifiers (e.g., unique alpha-numeric character strings) and arranged chronologically in accordance with a time and/or date of receipt of the corresponding work elements.

In some implementations, a categorization and prioritization engine of computing system 120 (e.g., categorization and prioritization engine 122) may access case record 133, which includes data characterizing user 102, user 102's account, and user 102's billing inquiry, and may assign the work element associated with case record 133 to one of a plurality of work categories. For example, the work categories may be established by the electrical utility, and may include, but are not limited to, service inquiries related to a status and/or modification to a customer's electrical service, billing inquiries related to a customer's current or prior invoice, distribution-network inquiries related to location and disposition of components of the electrical utility's distribution network, and general inquiries related to the electrical utility and/or its personnel. The electrical utility may use any appropriate work categories capable of characterizing a nature and purpose of incoming work elements, e.g., customer inquiries.

Categorization and prioritization engine 122 may, in some aspects, assign the work element (e.g., user 102's inquiry) to a corresponding work category based on an application of stored categorization logic (e.g., as stored within data repository 130) to portions of data included within case record 133. For example, case record 133 may indicate that the subject of user 102's inquiry relates to “billing” (e.g., as specified in customer portal 104), and the stored categorization logic may specify an assignment, to the “invoice inquiry” category, of any inquiry having a subject related to “billing.” Additionally or alternatively, case record 133 may include a textual description of user 102's inquiry (e.g., “My bill was very high last month—can you please verify,” as input by user 102 into customer portal 104), and the stored categorization logic may specify an assignment, to the “invoice inquiry” category, of any inquiry associated with a textual description that includes the term “billing.” The categorization and prioritization engine 122 may assign work elements to any appropriate work categories in accordance with any additional or alternate categorization logic.

The categorization and prioritization engine 122 may apply one or more machine learning algorithms to case data 133 (e.g., which specifies user 102's inquiry) and data identifying previously categorized and resolved work elements (e.g., prior customer inquiries stored within case database 132) to adaptively assign user 102's inquiry to a corresponding one of the work categories. For instance, computing system 120 may input portions of case data 133 and the data identifying the previously categorized and resolved customer inquiries into one or more neural networks (not shown in FIG. 1), which may identify patterns between characteristics of the previously categorized and resolved customer inquiries and user 102's inquiry (e.g., a presence of common text strings within the textual description, similar time and date of receipt, similarities in account information, etc.), identify correlations between these characteristics and previously assigned work categories, and assign user 102's inquiry to an appropriate work category.

By way of example, based on portions of case data 133 and the data identifying the previously categorized and resolved inquiries, the machine learning algorithms applied by categorization and prioritization engine 122 may establish that the textual description of user 102's inquiry include the terms “bill” and “verify”, and may identify patterns indicating an assignment to the “invoice inquiry” category of previously resolved customer inquiries that include these terms. Additionally, in some instances, the machine learning algorithms may establish that patterns indicating an assignment, to the “invoice inquiry” work category, of previously resolved inquiries received at computing system 120 within a particular time period prior to an invoice's due date (e.g., three days).

In some instances, using any of the example processes described above, categorization and prioritization engine 122 may assign user 102's inquiry to the “invoice inquiry” work category, and may add data indicative of the assigned “invoice inquiry” work category to case record 133 within case database 132. In additional aspects, once categorized, categorization and prioritization engine 122 may establish a priority of user 102's inquiry within the unresolved and categorized inquiries included within workflow queue 134, and additionally or alternatively, the priority of user 102's inquiry among those unresolved inquiries assigned to the “invoice inquiry” category. Categorization and prioritization engine 122 may, in certain aspects, determine the priority of user 102's inquiry based on an application of prioritization logic to portions and/or characteristics of user 102's inquiry, e.g., as stored within case record 133, and may assign a numerical value indicative of the determined priority to user 102's inquiry.

By way of example, for an inquiry categorized as an “invoice” inquiry, the prioritization logic may determine the inquiry's priority based on a proximity of a current date to a due date of an outstanding invoice, and additionally or alternatively, based on a consumption of electricity by the account holder during one or more prior billing cycles. For instance, the prioritization logic may assign a priority of “1” to an invoice inquiry involving an invoice having a due date in less than ten days and/or an account having an average electricity monthly consumption greater than 2,000 KWh/month. Further, in some instances, the prioritization logic may assign a priority of “2” to an invoice inquiry involving an invoice having a due date that falls between ten and fifteen days into the future and/or an account having an average electricity monthly consumption between 1,000 KWh/month and 2,000 KWh/month, and may assign a priority of “3” to an invoice inquiry involving an invoice having a due date that falls more than fifteen days into the future and/or an account having an average electricity monthly consumption less than 1,000 KWh/month.

As an example, categorization and prioritization engine 122 may establish that user 102's inquiry corresponds to an “invoice” inquiry involving a dispute of user 102's electricity consumption during a prior billing cycle, which may be set forth on an outstanding invoice having payment due to the electrical utility in three days. Using any of the example processes described above, categorization and prioritization engine 122 may assign a priority of “1” to user 102's inquiry, and may store data indicative of the assign priority within case record 133. In some aspects, and as described below, an allocation engine of computing system 120 (e.g., allocation engine 124) may identify an employee of the electrical utility (e.g., an agent) that is both available and capable to resolve user 102's inquiry prior to the due date, and may automatically allocate user 102's inquiry to the identified agent for resolution.

In one aspect, allocation engine 124 may establish a target resolution time for user 102's invoice inquiry based on an application of allocation logic to corresponding characteristics of user 102's invoice inquiry. For example, allocation engine 124 may access case record 133 within case database 132 to obtain data characterizing user 102's invoice inquiry, which may include, but is not limited to, the assigned work category (e.g., an “invoice” inquiry), the established priority (e.g., priority “1”), an account type (e.g., residential), data identifying user 102's account (e.g., account number, etc.), and data identifying user 102 (e.g., name, address, specified contact channel, email address, etc.).

Further, in some aspects, allocation engine 124 may also access the allocation logic (e.g., as stored within data repository 130), which specify target resolution times for various inquiries assigned to the electrical utility's work categories. The allocation logic may, for example, specify an expected agent resolution time of one hour for invoice inquiries involving residential and commercial accounts having any prior monthly consumption. Based on the allocation logic, allocation engine 124 may allocate up to one hour of work time for an available and capable agent to resolve user 102's invoice inquiry, and may store data indicative of the work time allocated to resolve user 102's inquiry within case data 133.

Additionally, in certain aspects, computing system 120 may maintain within data repository 130 data identifying agents employed by the electrical utility to resolve incoming customer inquiries (e.g., within agent database 138). For example, the electrical utility may employ hundreds or even thousands of individual agents to resolve the invoice, service-related, distribution-related, and/or general inquiries received from customers across various communications channels, which include, but are not limited to, the web-based inquiries described above, email inquiries having corresponding attachments), inquiries transmitted by facsimile, inquiries received via telephone and manually input into computing system 120 by one or more agents, inquiries received by postal mail, and in-person inquires received by agents working at a customer service center of the electrical utility.

These agents may possess skill sets (e.g., as obtained through training or experience) that facilitate resolution of customer inquiries, and agent database 138 may include records that not only identify the corresponding agents, but also identify their skills sets, e.g., which include primary and/or secondary skills. For example, a primary skill of an agent may include, but is not limited to, a resolution of invoice inquiries, service-based inquiries, distribution-based inquiries, or general inquiries, and the agent's secondary skills may include, but are not limited to, a resolution of invoice inquiries for residential customers, commercial customers, customers characterized by elevated levels of electricity consumption, customers in particular demographic groups (e.g., the elderly), and/or customer disposed in particular geographic areas.

Additionally, in some instances, computing system 120 may track, for each of the agents, the portion of a workday previously allocated to queued inquiries, and the portion of the workday that is unallocated and available to resolve additional customer inquiries upon receipt, queuing, categorization, and prioritization by computing system 120. Computing system 120 may, in some instances, store data indicative of each agent's unallocated and available work time within corresponding data records, which allocation engine 124 may update to reflect an allocation of addition incoming inquiries to particular agents, as described below.

For instance, and based on the data obtained from case data 133, allocation engine 124 may determine that user 102's invoice inquiry requires an agent capable of resolving invoice inquiries (e.g., as a primary skill) and additionally, an agent capable of resolving inquiries involving residential account (e.g., as a secondary skill). Further, allocation engine 124 may also establish that the agent requires at least one hour of available work time to resolve user 102's invoice inquiry (e.g., based on the expected agent resolution time for an invoice inquiry).

For example, allocation engine 124 may access agent database 138 and obtain data records associated with corresponding agents, and may parse the obtained data records to identify one or more of the agents (e.g., available agents) having at least one hour of worktime available and unallocated to other inquiries. Based on the data records of these available agents, allocation engine 124 may further select a subset of the available agents whose primary skills include invoice inquiries (e.g., available and capable agents), and may allocate user 102's invoice inquiry to a corresponding one of the available and capable agents for resolution. Additionally or alternatively, allocation engine 124 may further filter the available and capable agents to identify one or more agents whose secondary skills include a resolution of inquiries involving residential accounts, and may allocate user 102's invoice inquiry to a corresponding one of these identified agents for resolution.

For example, as illustrated in FIG. 2B, allocation engine 124 may access case record 133 to obtain data 240, which indicates that user 102's inquiry involves a residential account, that user 102's inquiry is categorized as an invoice inquiry, and the invoice inquiry is associated with a target resolution time of one hour. Further, by way of example, allocation engine 124 may access agent database 138 and obtain data records 252, 254, and 256, which corresponding, respectively to agents “Jim,” “Mark,” and “Mary.”

Data record 252 may, for instance, indicate that Jim has 1.3 hours of available work time, that Jim's primary skills include a resolution of service inquiries, and that Jim's secondary skills include a resolution of inquiries involving residential accounts. Data record 254 may indicate that Mark has 0.4 hours of available work time, that Mark's primary skills include a resolution of invoice inquiries, and that Mark's secondary skills include a resolution of inquiries involving commercial accounts. Further, data record 256 may indicate that Mary has 1.2 hours of available work time, that Mary's primary skills include a resolution of invoice inquiries, and that Mary's secondary skills include a resolution of inquiries involving residential accounts.

In some aspects, using any of the example processes described above, allocation engine 124 may determine that Jim and Mary are both available to resolve user 102's inquiry, as each is associated with greater than one hour of available time. As Jim's primary skills include the resolution of services inquiries, allocation engine 124 may allocate user 102's inquiry to Mary, whose primary skills include the resolution of residential accounts, and which are consistent with the residential account associated with user 102's inquiry. In certain aspects, allocation engine 124 may update data record 256 within agent database 138 to reflect the allocation of user 102's invoice inquiry to Mary.

In addition, In addition, the system can allocate work elements using performance data for agents. For example, the computing system 120 (e.g., through workflow engine 126) can monitor and capture data indicative of a performance of one or more agents during resolution of allocated inquiries, and may derive and store one or more known performance indicators (KPI) for these agents within corresponding data records of agent database 138. The agent KPIs may include, but are not limited to, an average resolution time for various work categories, a metric indicative of a comparison of the average and target resolution times for the work categories, a percentage completion rate of allocated tasks on a daily, weekly, or monthly basis, and/or metrics indicative of the agent's management of unallocated time. In some aspects, allocation engine 124 may also allocate user 102's invoice inquiry to an available and capable agent based on one or more of the derived KPIs, e.g., to a corresponding one of the available and capable agents having the lowest average resolution time for invoice inquiries.

In some implementations, allocation engine 124 may apply one or more machine learning algorithms to portions of the stored performance data (e.g., stored KPIs within agent database 138) and portions of case data 133 (e.g., which specifies user 102's inquiry) to adaptively allocate user 102's inquiry to an available agent that, in the past successfully resolved inquiries that share one or more characteristics in common with user 102's inquiry. For example, allocation engine 124 may access and input portions of the stored performance data and case data 133 into one or more neural networks, which may identify an available agent of the electrical utility that, regardless of the agent's primary and/or secondary skills, efficiently and successfully resolved invoice inquiries similar in nature and/or scope to user 102's inquiry (e.g., a billing dispute regarding an invoice for a residential account having a due date that falls in the next three days).

In some instances, allocation engine 124 may allocate user 102's inquiry to that available agent, and additionally or alternatively, may couple the outcome of the applied machine learning algorithms and/or neural networks to further filter the one or more available and capable agents identified using the example processes described above.

Referring back to FIG. 1, allocation engine 124 may identify agents 142, 144, and 146 (e.g., “Jim,” “Mark”, and “Mary,” respectively) that are available to resolve user 102's invoice inquiry (e.g., that have more than one hour of unallocated work time), and based on the primary and secondary skills of agents 142, 144, and 146 (e.g., as set forth, respectively, within data records 252, 254, and 256 of agent database 138), allocation engine 124 may allocate user 102's inquiry to agent 146 (i.e., “Mary”) for processing and resolution. In some aspects, allocation engine 142 may generate, and store within case record 133, additional data that reflects the allocation of user 102's invoice inquiry to agent 146. Additionally, in further aspects, a workflow engine of computing system 120 (e.g., workflow engine 126) may transmit data that characterizes user 102's invoice inquiry (e.g., the corresponding inquiry identifier, data identifying user 102, user 102's account, and/or a nature of user 102's inquiry, a due date, a target resolution time, an assigned category and priority, etc.) to a system operated by agent 146 (e.g., system 148). Agent system 148 may, in some instances, present portions of the transmitted data identifying user 102's inquiry, and/or additional data identifying other allocated inquiries and a real-time performance of agent 146, within a corresponding agent dashboard, e.g., graphical user interface (GUI) 150.

FIG. 2C illustrates an example configuration of interface elements within GUI 150. For example, in FIG. 2C, GUI 150 may include an inbox 260 that presents, to agent 146, a visual representation of one or more inquiries currently allocated to agent 146, arranged in accordance with their assigned categories, priorities, and underlying due dates, e.g., the due dates of the invoices, service requests, etc., associated with the allocated inquiries. In certain instances, each entry within inbox 260 (e.g., entry 260A) may be associated with a corresponding one of the allocated inquiries, and may be linked to a corresponding identifier (e.g., “action” identifier), priority, communication channel (e.g., the communications channel through which computing system 120 received the inquiry), work category, due date information (e.g., a due date, a due status, and a “due in” counter), and status information (e.g., a status of the inquiry, etc.).

For example, entry 260A may correspond to an inquiry having an identifier value of “ACT-000-0170,” which may be received by computing system 120 through an email channel, and to which categorization and prioritization engine assigned a work category of “invoice inquiry” and a priority of “1.” Additionally, a payment for the invoice associated with entry 260A may be due at the electrical utility at 12:29 p.m. on Apr. 27, 2016, and entry 260A may indicate that due date occurs in eleven hours, thirteen minutes, and one second. Additionally, entry 260A may indicate that the resolution status of the underlying inquiry is “In Work,” which indicates that agent 146 may current be processing the inquiry for resolution.

Similarly, by way of example, entry 260B may correspond to an additional inquiry having an identifier value of “ACT-000-0031,” and which may be transmitted to the electrical utility by U.S. mail, and which may be entered into computing system 120 by an employee at a corresponding terminal. Further, for instance, categorization and prioritization engine assigned a work category of “invoice inquiry” and a priority of “none,” and an outstanding payment for the invoice associated with entry 260B may be due at the electrical utility at 12:29 p.m. on Apr. 28, 2016, and entry 260B may indicate that due date occurs in one day, eleven hours, thirteen minutes, and one second. Additionally, entry 260B may indicate that the resolution status of the underlying inquiry is “Allocated,” which indicates that agent 146 has not picked up the additional inquiry for resolution.

In some aspects, the entries presented within inbox 260 may be arranged in accordance with their assigned work categories (e.g., invoice inquiries, service-based inquiries, distribution-based inquiries, general inquiries, etc.). Further, within a particular work category, inbox 260 may arrange the entries in accordance with their assigned priorities (e.g., “1,”, “2,” “3,” “none,” etc.), and within a particular assigned priority, in accordance with the due dates of associated with the underlying invoices or requests. The inbox 260 may present any appropriate elements of inquiry data, including any additional or alternate status identifiers, that would be appropriate to the electrical utility and the underlying inquiries or requests. For instance, inbox 260 may present a “Pending” status identifier in an event where one or more portions of the underlying inquiry or request require verification by additional employees of the electrical utility, third-parties (e.g., contractors), and/or other business, governmental or business entities, and may present an “Unable to Work” status identifier when capacity issues prevent agent 146 from processing the underlying inquiry or request.

Further, in FIG. 2C, GUI 150 may also include additional interface elements 262 that present, to agent 146, a real-time indication of known performance indicators (KPIs) indicative of agent 146's performance during a current work day and across one or more prior workdays. For example, interface elements 262 may include, but are not limited to, charts indicative of the agent 146's time-evolving performance (e.g., chart 262A), charts indicative of agent 146's resolution of inquiries allocated for resolution during a current workday (e.g., chart 262B) and on future workdays (e.g., chart 262C), and tabular data 262D describing a handling time during which agent 146 processes a current inquiry toward resolution, an expected or target resolution time for that inquiry, a ratio of the handling and target times, an average handling resolution time for agent 146 (e.g., an average time spent by agent 146 resolving inquiries), and/or data indicative of a comparative performance of one or more of agent 146's peers. Additionally, in some aspects, interface elements 262 may also include additional element 262E (e.g., a text box and/or pull-down menu) that allow agent 146 to provide input to system 148 that accounts for unallocated time.

In certain aspects, and referring back to FIG. 1, agent 146 may view GUI 150 and may identify an inbox entry corresponding to user 102's invoice entry. Agent 146 may provide input, via agent system 148, that selects the presented entry corresponding to user 102's invoice entry and initiates resolution processing of user 102's invoice inquiry. Agent system 148 may, in some instances, transmit data indicative of the initiation of resolution processing, which may be detected by workflow engine 126. In response to the detected data, workflow engine 140 may initiate a counter that tracks a total time spent by agent 146 during resolving user 102's invoice inquiry. Workflow engine 126 may also store data indicative of a time and date at which agent 146 initiated the processing of user 102's invoice inquiry within corresponding portions of case record 133 and agent database 138 (e.g., data record 256, which corresponds to agent 146), and may transmit data instructing system 1 48 to modify a presented status of user 102's inquiry (e.g., within inbox 260 of GUI 150) to reflect agent 146's initiation of work on user 102's invoice inquiry. For example, system 148 may change the “Status” of the entry in inbox 260 from “Allocated” to “In Work,” to indicate that agent 146 initiated resolution processing on user 102's invoice inquiry.

In certain aspects, when agent 146 provides inputs that selects the presented entry corresponding to user 102's invoice inquiry, and initiates work to resolve user 102's invoice inquiry, agent system 148 may access stored data associated with user 102's invoice inquiry (e.g., data identifying user 102, user 102's account, and/or a nature of user 102's invoice inquiry, as stored within case record 133), which may be presented to agent 146 through an additional, inquiry-specific graphical user interface (GUI). Additionally or alternatively, the inquiry-specific GUI provides the agent 146 with access data identifying correspondence relating to user 102's invoice inquiry (e.g., emails exchanged between client device 110 and computing system 120 to initiate the invoice inquiry, requests for additional information transmitted from computing system 120 to client device 110 during processing of the invoice inquiry, user 102's response to these requests, etc.), and further, one or more documents associated with user 102's invoice inquiry (e.g., electronic copies of underlying invoices, scanned copies of written or printed correspondence, electronic copies of additional documentation, etc.).

Computing system 120 may, for example, store the electronic copies of the correspondence and/or the documents, e.g., within data repository 130, and may transmit information identifying the correspondence and/or documents and the locations of storage, which may be rendered for presentation within the inquiry-specific GUI (e.g., as hyperlinks that access the stored correspondence or documents). In some aspects, system 148's presentation of inquiry data, correspondence, and associated documents within a single, inquiry-specific GUI may reduce the time spent by agent 146 in searching various sources of correspondence and documents (e.g., multiple email inboxes, etc.), and provides the agent 146 with an opportunity to process user 102's invoice inquiry toward resolution in a more efficient manner.

In certain aspects, agent 146 (e.g., “Mary”) may process and review user 102's invoice inquiry against various sources of data stored by computing system 120 (e.g., data indicative of user 102's current consumption of electricity, data indicative of user 102's consumption during prior months, data indicative of a consumption of electricity by account that are demographically similar to user 102, etc.), and agent 146 may provide input to system 148 that indicates a resolution of user 102's invoice inquiry. In one aspect, and in response to the provided input, agent system 148 may present, to agent 146, one or more templates that merge user 102's contact information with predefined message data, and that enable agent 146 to generate an appropriate response to user 102's invoice inquiry.

For example, the response templates may include one or more automated and/or a semi-automated response templates linked to user 102's contact information, e.g., an email address specified by user 102 and stored within case data 133. In response to input provided by agent 146 that selects one of the automated response templates (e.g., a keystroke sequence, a selection of an interface element by clicking, touching, etc.), agent system 148 may automatically generate a response document by populating the automated response template with user 102's contact information. In other instances, agent 146 may provide input to agent system 148 that selects one of the semi-automated response templates, and agent system 148 may render the portions of the selected semi-automated response template for presentation to agent 146. Agent 146 may, for instance, provide textual input to agent system 148 that completes one or more open field of the semi-automated template, and agent system 148 may generate a response document by populating the semi-automated response template with user 102's contact information and by merging the populated response template with the textual input provided by agent 146. The generated response documents may, for example, include text-based email documents linked to user 102's email address and viewable through an email application executed by client device 110, text files that include elements of plain text suitable for viewing by multiple applications executed by client device 110, and/or a document (e.g., a Microsoft Word™ document) viewable by a word processing application executed by client device 110.

In certain aspects, agent system 148 may transmit the generated response document (e.g., an email, text, or Word™ document) to computing system 120 using one or more communications channels specified within the corresponding inquiry data (e.g., stored in case data 133). Computing system 120 may, for example, modify portions of case record 133 to reflect a receipt of the response document, and may store the received response document within a portion of data repository 130 and associate the stored response document with case record 133. The storage of the received response document and the association of the stored response document with case record 133, which include data specify user 102's invoice inquiry, may comport with one or more audit policies imposed internally by the electrical utility, and additionally or alternatively, by one or more third-party auditors or regulatory entities.

The received response document may, for example, include an email, which computing system 120 may transmit to the email address addressed specified by user 102. In other instances, the received response document may include a Word™ document, which computing system 120 may transmit to client device 110 as an attachment to an email.

Client device 110 may receive the response document transmitted by computing system 120, and may render the received response document for presentation to user 102 through a corresponding response portal, e.g., response portal 105. For example, in resolving user 102's invoice inquiry, agent 146 may determine that the electrical utility's records regarding user 102's electrical meter are inaccurate, and the response document may indicate that user 102's outstanding account balance has been adjusted to reflect the error (e.g., “Your outstanding balance included an error. We reduced the balance accordingly.”). In other aspects, agent 146 may determine that the electrical utility's records regarding user 102's electrical meter are indeed accurate, and the response document may indicate that user 102's outstanding account balance is accurate as invoiced.

Additionally, as described above, workflow engine 126 may detect agent 146's resolution of the inquiry, and may determine a time and/or date corresponding to the resolution of user 102's invoice inquiry by agent 146 Workflow engine 126 may determine a total time required by agent 146 to resolve the invoice inquiry, and may deduct that total resolution time from an amount of unallocated time available to agent 146 for resolving inquiries during a current workday (e.g., as stored within data record 256 of agent database 138).

In further aspects, workflow engine 126 may derive one or more known performance indicators (KPI) for agent 146 based on the total resolution time, and additionally or alternatively, may update one or more previously derived KPIs to reflect the total resolution time. For example, the total resolution time may correspond to forty-eight minutes, which workflow engine 126 may determine represents 80% of the target resolution time of sixty minutes. In other aspects, workflow engine 126 may update agent 146's average resolution time for invoice inquiries and/or a completion rate of allocated tasks to reflect the resolution of user 102's invoice inquiry.

Workflow engine 126 may, in some instances, store the total resolution time and the derived and/or updated KPIs within a portion of data repository 130 associated with agent 146 (e.g., as a portion of data record 256 of agent database 138). The storage of the total resolution time and the updated and/or derived KPIs may generate a fully auditable record of agent 146's performance that is visible to agent 146, agent 146's peers, and further, one or more managers of agent 146.

Further, and as described above, workflow engine 126 may transmit the total resolution time and additionally or alternatively, portions of the derived or updated KPIs to agent system 148, which may update portions of the GUI 150 (e.g., interface elements 262) to reflect the total resolution time and the derived or updated KPIs. In certain aspects, the update in real-time of agent 146's displayed performance data may provide agent 146 with an opportunity for self-evaluation, which may identify and remedy deficiencies that impact negatively agent performance.

In other instances, workflow engine 146 may also transmit the total resolution time and additionally or alternatively, portions of the derived or updated KPIs to systems operated by one or more managers of agent 146. The systems, e.g., manager systems, may process the received performance data to generate reports indicative of agent 146's performance, both in resolving user 102's invoice inquiry and in aggregate over one or more prior resolved inquiries (e.g., average resolution time, etc.), and reports comparing agent 146's performance against a performance of other agents, e.g., agents 142 and 144, in resolving similar inquiries. The generated reports may, for example, be rendered for presentation to the manager via interface elements similar those described above in GUI 150 (e.g., interface elements 262), and additionally or alternatively, the manager systems may generate electronic copies of these reports for review by the managers (e.g., in text, Word™, or PDF form).

For example, as described above, agent 146 may resolve user 102's invoice inquiry in forty-eight minutes, which represents 80% of the target resolution time of sixty minutes. Based on the generated reports, however, agent 146's manager may determine that 75% of agent 146's peers resolved similar inquiries in thirty minutes (e.g., 50% of the target resolution time), while one 5% of agent 146's peers resolved similar inquiries in greater than the target resolution time of sixty minutes. In some aspects, these comparative performance metrics assist the managers in identifying specific subsets of agents that require additional training (e.g., the 5% that exceeded the target resolution time) and additionally or alternatively, identify potential modifications to the target resolution times that further increase efficiency and optimize the agents' collectively work time.

Using these techniques, a computing platform maintained by an enterprise, e.g., an electrical utility, may adaptively allocate incoming elements of work, e.g., customer invoice inquiries, to those agents having bandwidth to resolve the incoming work elements and skill sets that are tuned to efficiently and accurate resolve these incoming work elements to the satisfaction of the enterprise's customers. The adaptive allocation of incoming work elements to an agent, without intervention from employees of the enterprise and based on the agent's prior performance, may optimize the agent's throughput by ensuring not only that the agents' working time is fully allocated to incoming inquiries, but by allocating subsets of these incoming inquiries to agents having complimentary skill sets obtained either through training or experience.

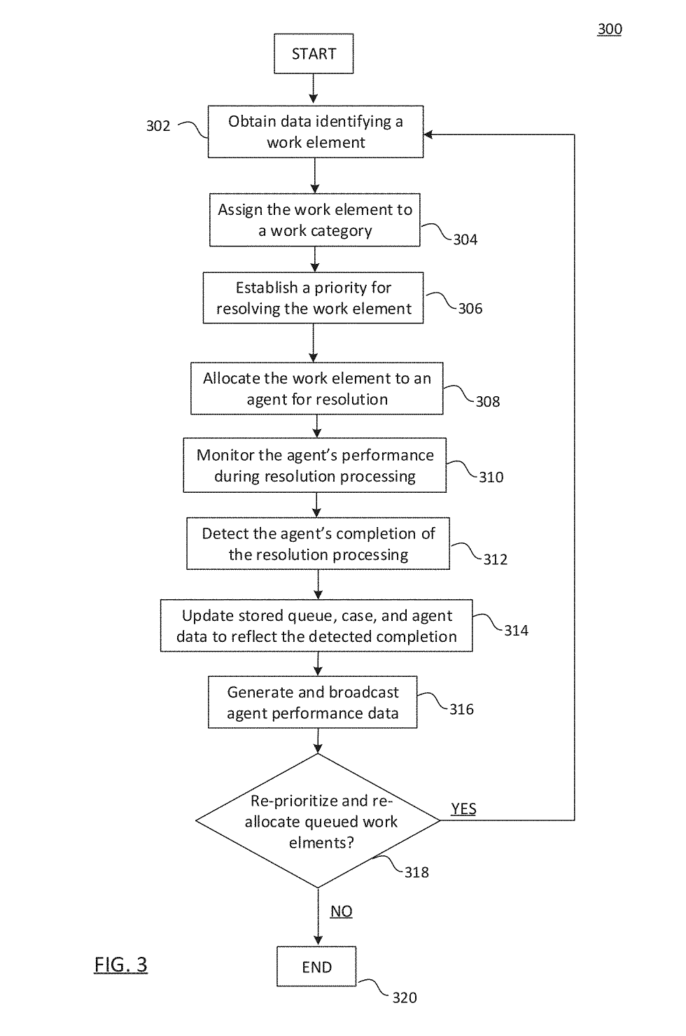

FIG. 3 is a flowchart of an example process 300 for allocating and balancing incoming elements of work within an enterprise. In certain aspects, a computer system (e.g., computing system 120) may perform the steps of example process 300. The computing system 120 can receive elements of work through various communications channels, categorize and prioritize these work elements based on predetermined business logic and/or identified trends within data characterizing previously categorized and resolved work elements, and to automatically allocate the categorized and prioritized work elements to agent systems for resolution.

As described above, the incoming work elements may include one or more inquiries from customers of the enterprise, e.g., customers of an electrical utility. The computing system 120 can identify an operator of an agent system (e.g., an agent) having available bandwidth to resolve a particular customer inquiry prior to a due date and further, having a set of skills that are commensurate with the subject matter and nature of the particular customer inquiry. Additionally, when performed by computing system 120, the steps of example method 300 may generate real-time metrics that indicate the agent's performance during resolution of the particular customer inquiry, and that compare the agent's performance against a performance of one or more peer agents when resolving similar inquiries. Although described in term of customer inquiries, the disclosed implementations are not limited to these examples of work elements, and in other aspects, the processes described below may be applied to any additional or alternate type of work element that would be appropriate to computing system 120 and to the enterprise.

For example, a customer of the electrical utility (e.g., user 102 of FIG. 1) may receive a monthly invoice (e.g., invoice 103 of FIG. 1), and upon review of invoice 103, user 102 may determine that the outstanding balance is higher than expected and inconsistent with prior monthly balances. In some aspects, user 102 may access, via a communications device (e.g., client device 110 of FIG. 1), a web page or other digital portal provided by the electrical utility (e.g., a graphical user interface generated by a mobile application provided by the electrical utility), and as described above, may provide input to client device 110 that establishes an inquiry regarding the higher-than-expected balance set forth in invoice 103. In some instances, client device 110 may package and transmit the provided input as work-element data, and may transmit the work-element data to computing system 120 through, for example, through one or more programmatic interfaces, e.g., an application programming interface (API) associated with and capable of exchanging data with web browsers and other application programs executed by client device 110.

In some implementations, computing system 120 may receive the work-element data transmitted from client device 110 (e.g., in step 302). The received work-element data may, for example, identify an element of work, e.g., user 102's inquiry regarding the higher-than-expected balance set forth in invoice 103. Computing system 120 may be configured to parse the received work-element data to obtain the information identifying user 102, user 102's preferred communications channel, user 102's account, and/or the nature of user 102's inquiry. Further, using any of the example processes described above, computing device 102 may also be configured to establish a case record associated with user 102's inquiry within a case database (e.g., new case record 133 in case database 132 of FIG. 1), establish an entry corresponding to user 102's inquiry in a workflow queue (e.g., queue entry 135 of workflow queue 134 of FIG. 1), and as described above, may link the entry with case record 133 within case database 132. Additionally, using any of the example processes described above, computing system 120 may perform various background operations that generate and transmit a message confirming receipt of the work element (e.g., user 102's inquiry) to client device 110.

In additional or alternative aspects, computing system 120 may obtain data in step 302 that identifies a previously received and queued work element. For example, in step 302, computing system 120 may access workflow queue 134 and identify an entry corresponding to a previously queued work element (e.g., queue entry 135, which may correspond to user 102's inquiry). Based on the identified queue entry, computing system 120 may identify a stored case record associated with the previously queued work element (e.g., case record 133 populated with data characterizing user 102's inquiry), and computing system 120 may extract portions of the stored case record as work-element data in step 302. For example, and as described above, the work-element data characterizing user 102's inquiry may include, but is not limited to, data identifying user 102, user 102's preferred communications channel, user 102's account, and/or the nature of user 102's inquiry.

In step 304, computing system 120 may also perform operations that assign the identified work element (e.g., user 102's inquiry) to one of a plurality of work categories (e.g., in step 304). For example, the workflow categories may be established by the enterprise (e.g., the electrical utility), and as described above, may include, but are not limited to, service-based inquiries, invoice inquiries, distribution-based, and general inquiries.

In some aspects, in step 304, a categorization and prioritization engine of computing system 120 (e.g., categorization and prioritization engine 122) may access case record 133, and may assign user 102's inquiry to a corresponding workflow category based on an application of stored categorization logic (e.g., as stored within data repository 130) to portions of data included within case record 133. For example, as described above, the stored categorization logic may include, but are not limited to, subject-based categorization logic that assigns user 102's inquiry to an appropriate workflow category based on user 102's specification of an inquiry subject (e.g., a “Billing” subject within digital portal 104), and description-based categorization logic that assigns user 102's inquiry to an appropriate workflow category based on a presence of specific keywords within a textual description of the inquiry (e.g., as provided by user 102 to digital portal 104).

In other aspects, and using any of the example processes described above, categorization and prioritization engine 122 may apply one or more machine learning algorithms to case data 133 and data identifying previously categorized and resolved inquiries (e.g., as stored within case database 132) to adaptively assign user 102's inquiry to a corresponding one of the workflow categories in step 304. For instance, computing system 120 may input portions of case data 133 and the data identifying the previously categorized and resolved inquiries into one or more neural networks which may identify patterns between characteristics of the previously categorized and resolved inquiries and user 102's inquiry (e.g., a presence of common text strings within the textual description, similar time and date of receipt, similarities in account information, etc.), establish correlations between these characteristics and previously assigned work categories, and assign user 102's inquiry to an appropriate workflow category.

Further, in additional aspects, categorization and prioritization engine 122 may also generate or modify a portion of the categorization logic to reflect the identified patterns and/or established correlations (e.g., as identified or established using any of the machine-learning techniques described above). For example, the applied machine-learning techniques may identify, within the data identifying previously categorized and resolved inquiries, a pattern between a presence of specific terms in an inquiry (e.g., “billing” or “high”) and an assignment of that inquiry to the “invoice” workflow category. Categorization and prioritization engine 122 may, in some instances, establish and store in data repository 130 a new categorization rule that reflects the identified pattern, which may be applied by categorization and prioritization engine 122 to incoming customer inquiries using any of the example processes described above.

In the example described above, in step 304, the identified work element may correspond to user 102's inquiry, and categorization and prioritization engine 122 may assign user 102's inquiry to the “invoice inquiry” work category, and may add data indicative of the assigned “invoice inquiry” work category to case record 133 within case database 132. In additional aspects, categorization and prioritization engine 122 may establish a priority of user 102's inquiry for subsequent resolution (e.g., in step 306). Categorization and prioritization engine 122 may, in certain aspects, determine the priority of user 102's inquiry based on an application of prioritization logic to portions and/or characteristics of user 102's inquiry, e.g., as stored within case record 133, and may assign a numerical value indicative of the determined priority to user 102's inquiry.

For example, categorization and prioritization engine 122 may establish that user 102's inquiry corresponds to an “invoice” inquiry involving a dispute of user 102's electricity consumption during a prior billing cycle, which may be set forth on an outstanding invoice having payment due to the electrical in three days. Using any of the example processes described above, categorization and prioritization engine 122 may apply one or more of the prioritization rules to user 102's inquiry and assign a priority of “1” to user 102's inquiry (e.g., a highest priority), and may store data indicative of the assigned priority within case record 133.

Additionally, in some aspects, computing system 120 may perform operations that adaptively and automatically allocate the obtained work element (e.g., user 102's inquiry) to an agent of the enterprise capable of resolving the work element in accordance with the established priority (e.g., in step 308). For example, as described above, the work element may correspond to user 102's inquiry, and in step 308, an allocation engine of computing system 120 (e.g., allocation engine 124) may allocate user 102's inquiry to an agent of the electrical utility that is available and capable to resolve user 102's inquiry prior to the due date.

For example, in step 308, allocation engine 124 may access allocation logic that specifies resolution times for the electrical utility's work categories (e.g., as stored within data repository 132), and based on the allocation logic, establish a target resolution time for user 102's invoice inquiry. For example, the allocation logic (e.g., as established by the electrical utility) may specify a target resolution time of one hour for invoice inquiries involving residential and commercial accounts having any prior monthly consumption. Based on the allocation logic, allocation engine 124 may allocate up to the target resolution time, e.g., one hour, of work time for an available and capable agent to resolve user 102's inquiry, and may store data indicative of the work time allocated to resolve user 102's inquiry within case data 133.

Further, and as described above, computing system 120 may maintain within data repository 130 data identifying agents employed by the electrical utility to resolve incoming customer inquiries (e.g., within agent database 138). These agents may possess skill sets (e.g., as obtained through training or experience) that facilitate resolution of customer inquiries, and agent database, and agent database 138 may include records that not only identify the corresponding agents, but also identify their skills sets, e.g., sets primary and/or secondary skills. For example, a primary skill of an agent may include, but is not limited to, a resolution of invoice inquiries, service-based inquiries, distribution-based inquiries, or general inquiries, and the agent's secondary skills may include, but are not limited to, a resolution of invoice inquiries for residential customers, commercial customers, customers characterized by elevated levels of electricity consumption, customers in particular demographic groups (e.g., the elderly), and/or customer disposed in particular geographic areas. Additionally, in some instances, the records of agent database 138 may include, for each of the agents, a portion of the workday previously allocated to queued inquiries, and the portion of the workday that is unallocated and available to resolve additional customer inquiries.

In some aspects, one or more of the primary or secondary skills for a particular agent may be specified or identified by the particular agent, and additionally or alternatively, by a manager of the particular agent, e.g., based on a performance review. The particular agent and/or the manager may, however, be unable to identify skills developed by the particular agent based on the agent's experience in resolving inquiries from a variety of customer inquiries. In addition, computing system 120 may apply one or more of the example machine-learning techniques described above to portions of stored inquiry data (e.g., within case database 132) to identify experiential skills attained by the agent through a resolution of the various customer inquiries.

For example, the particular agent may be assigned a primary skill related to the resolution of service inquiries. The applied machine-learning algorithms may, in some instances, detect patterns indicating the particular agent's success in resolving service inquiries involving account holders disposed within specified geographic regions (e.g., neighborhoods, zip codes, etc.) and additionally or alternatively, in resolving service and invoice inquiries involving elderly customers. In some aspects, computer system 120 may assign additional primary or secondary skills to the particular agent based on the output of the machine-learning algorithms (e.g., to include as primary skills, invoice inquiries and services inquiries involving elderly customers), and store these data identifying these additional primary or secondary skills within corresponding data records of agent database 138. Through the application of machine-learning algorithms to a corpus of resolved inquiry data, the system can more accurately tune an agent's primary and secondary skill set to include not only a broad description of particular primary and secondary skills but also a more granular description of particular types of inquiries successfully resolved by the agent.

Referring back to FIG. 3, and using any of the example processes described above, allocation engine 124 may determine that the prioritized and categorized work element (e.g., user 102's invoice inquiry) requires an agent capable of resolving invoice inquiries (e.g., as a primary skill) and additionally, an agent capable of resolving inquiries involving residential account (e.g., as a secondary skill). Further, allocation engine 124 may also establish that the agent requires at least one hour of available work time to resolve user 102's invoice inquiry (e.g., based on the expected agent resolution time for an invoice inquiry).

In some implementations, in step 308, allocation engine 124 may access agent database 138 and obtain data records associated with corresponding agents capable of resolving customer inquiries received by computing system 120, and may parse the obtained data records to identify agents (e.g., available agents) having at least one hour of time available and unallocated to other inquiries. Based on the data records of these available agents, allocation engine 124 may further select a subset of the available agents whose primary skills include resolving invoice inquiries (e.g., available and capable agents), may allocate user 102's invoice inquiry to a corresponding one of the available and capable agents for resolution. Additionally or alternatively, allocation engine 124 may further filter the available and capable agents to identify one or more agents whose secondary skills include a resolution of inquiries involving residential accounts, and may allocate user 102's invoice inquiry to a corresponding one of these identified agents for resolution.

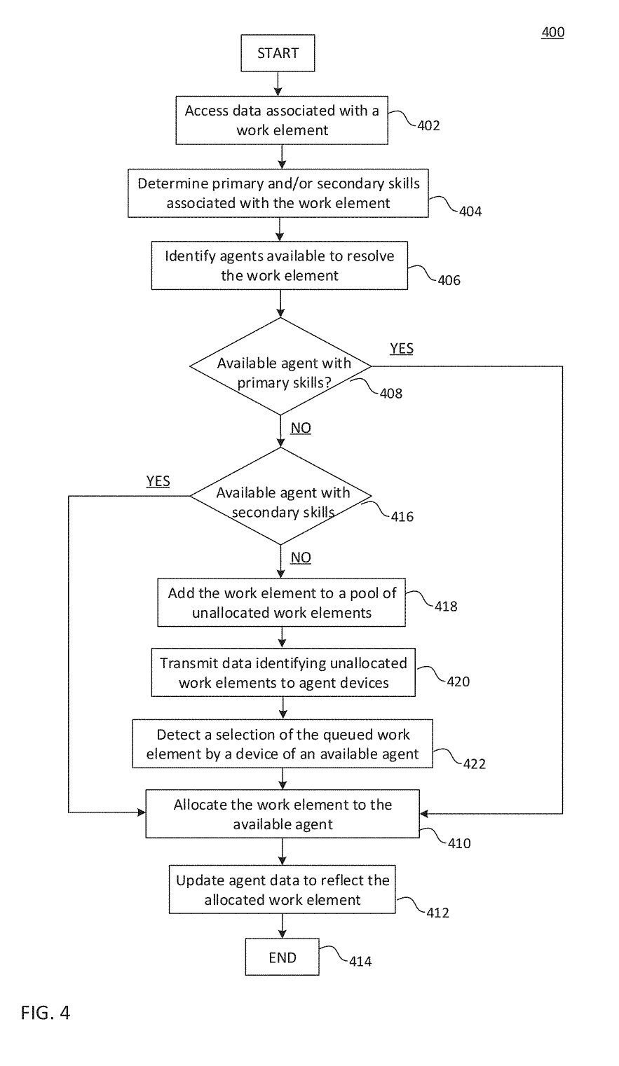

FIG. 4 is a flowchart of an example process 400 for allocating work elements to available agents based on primary and secondary skill sets. For example, an allocation engine of a computing system (e.g., allocation engine 124 of computing system 120) may perform the steps of example process 400. The allocation engine 124 can access data characterizing a queued element of work, e.g., a customer inquiry, identify primary and/or secondary skills associated with a resolution of the customer inquiry, and identify agents available to and capable of resolving the customer inquiry. In some implementations, allocation engine 124 may perform the steps of example process 400 to allocate user 102's invoice inquiry to an available and capable agent for resolution, as described above in step 308 of FIG. 3.

In certain aspects, in step 402, allocation engine 124 may access inquiry data identifying a work element (e.g., data identifying user 102, user 102's account, and/or a nature of user 102's inquiry, as stored within case records 133). Allocation engine 124 may, in some aspects, identify one or more primary and secondary skills associated with the resolution of the work element (e.g., in step 404). For example, and as described above, allocation engine 124 may determine that the resolution of user 102's inquiry requires primary skills that include a resolution of invoice inquiries, and secondary skills that include a resolution of inquiries involving residential accounts.

Additionally, allocation engine 124 may also establish a target resolution time for the work element based on, among other things, allocation logic and an assigned work category, and may identify one or more agents having an amount of unallocated work time that meets or exceeds the target resolution time (e.g., in step 406). For example, and as described above, allocation engine 124 may establish that user 102's inquiry (e.g., the work element) is categorized as an invoice inquiry, and based on portions of the allocation logic (e.g., as stored in data repository 130), may establish a target resolution time of one hour for user 102's invoice inquiry. Allocation engine 124 may also access a database of agent records (e.g., agent database 138) and identify one or more agents (e.g., “available” agents) whose available and unallocated work time meets or exceeds one hour during a current work day or on a workday prior to a due date associated user 102's invoice inquiry. Further, and based on the accessed agent records, allocation engine 124 may also identify one or more primary or secondary skills that characterize the available agents.

Allocation engine 124 may, in some instances, determine whether the primary skills of the available agents include a resolution of invoice inquiries (e.g., in step 408). If allocation engine 124 were to determine that the primary skills of one of the available agents include the resolution of invoice inquiries (e.g., step 408; YES), allocation engine 124 may allocate user 102's invoice inquiry to the available agent (e.g., in step 410), and may update a data record corresponding to the available agent within agent database 138 to reflect the allocated customer inquiry (e.g., in step 412). Example process 400 may then be complete in step 414.

Alternatively, if allocation engine 124 were to determine that the primary skills of the available agents fail to include the resolution of invoice inquiries (e.g., step 408; NO), allocation agent 124 may determine whether the secondary skills of the available agents include a resolution of inquiries involving residential accounts (e.g., in step 416). If allocation engine 124 were to determine that the secondary skills of an additional one of the available agents include the resolution of inquiries involving residential accounts (e.g., step 416; YES), allocation engine 124 may allocate user 102's invoice inquiry to the additional available agent and update agent database 138 using any of the example processes described above (e.g., in steps 410 and 412). Example process 400 may then be complete in step 414.

If, however, allocation engine 124 were to determine that the secondary skills of the available agents fail to include the resolution of inquiries involving residential accounts (e.g., step 416; NO), allocation engine 124 may add user 102's invoice inquiry to a pool of unallocated inquiries (e.g., in step 418), which allocation engine 124 may broadcast to devices and systems operated by the available agents, e.g., systems of agents 142, 144, and 146 of FIG. 1 (e.g., in step 420). For example, allocation engine 124 may access stored data identifying the pool of unallocated inquiries (e.g., as stored in data repository 130), and may establish a data record corresponding to user 102's invoice inquiry. In some aspects, allocation engine 124 may populate the data record with information identifying user 102's inquiry, e.g., as stored within case record 133, and may transmit potions of the information to the systems of the available agents.

In some aspects, the available agent systems may receive the transmitted data, and may present portions of the transmitted data to the available agents through a corresponding graphical user interface, e.g., GUI 150 of FIG. 1. For example, GUI 150 may present additional interface elements that indicate an unallocated status of user 102's inquiry, and request that one of the available agents volunteer to resolve user 102's inquiry despite the apparent mismatch with their primary and/or secondary skills. For example, one of the available agents (e.g., agent 142 of FIG. 1) may be experienced in resolving service inquiries for residential accounts, and may have 1.3 hours of available time is a current workday. Agent 142 may provide, to a corresponding agent system, input requesting the allocation of user 102's invoice inquiry for resolution during the current day, and the corresponding agent system may transmit an allocation request that includes portions of the provided input, along with an identifier of agent 142, to computing system 120.

Computing system 120 may receive the allocation request from the corresponding system, and based on the allocation request, allocation engine 146 may detect agent 142's request to resolve user 102's inquiry (e.g., in step 422). In some aspects, allocation engine 124 may allocate the user 102's inquiry to agent 142 and update agent database 138 using any of the example processes described above (e.g., in steps 410 and 412). Example process 400 may then be complete in step 414.

In some implementations, allocation engine 142 may allocate work elements (e.g., customer inquiries) to available agents based on the available agents' primary and/or secondary skills. For example, in step 410, allocation engine 124 may allocate user 102's inquiry to an available agent having primary skills that correspond to those associated with user 102's inquiry, and/or to an available agent having secondary skills that correspond to user 102's inquiry. In some aspects, however, allocation engine may determine that the primary and/or secondary skills of multiple available agents are consistent with those associated with user 102's inquiry. In some aspects, allocation engine 142 may access data indicative of a performance of the available agents during resolution of prior customer inquiries (e.g., as stored within corresponding data records of agent database 138), and may select one of the multiple available agents based on the accessed performance data.

For example, as described above, computing system 120 (e.g., through workflow engine 126) may monitor and capture data indicative of a performance of one or more agents during resolution of allocated inquiries, and may derive and store one or more known performance indicators (KPI) for these agents within corresponding data records of agent database 138. The agent KPIs may include, but are not limited to, an average resolution time for various categories of queries, a metric indicative of a comparison of the average and target resolution times for the categories of inquiries, a percentage completion rate of allocated tasks on a daily, weekly, or monthly basis, and/or metrics indicative of the agent's management of unallocated time.

In certain aspects, when allocation engine 124 determines that multiple available agents possess primary and/or secondary skills that are consistent with user 102's inquiry, allocation engine 124 may select one of the multiple available agents for allocation based on the one or more of the derived KPIs. For example, allocation engine 124 may determine that three available agents that possess primary skills that include the resolution of invoice inquiries (e.g., in step 408), or that four available agents possess secondary skills that include the resolution of inquiries involving residential accounts (e.g., in step 416), and allocation engine may allocate user 102's inquiry to the available agent associated with the having the lowest average resolution time for invoice inquiries (e.g., in step 410).

In some implementations, in other aspects, allocation engine 124 may apply one or more machine learning algorithms to portions of the stored performance data (e.g., stored KPIs within agent database 138) and portions of case data 133 (e.g., which specifies user 102's inquiry) to adaptively allocate user 102's invoice inquiry to an available agent that, in the past successfully resolved inquiries that chare one or more characteristics in common with user 102's invoice inquiry. For example, allocation engine 124 may access and input portions of the stored performance data and case data 133 into one or more neural networks, which may identify an available agent of the electrical utility that, regardless of the agent's primary and/or secondary skills, efficiently and successfully resolved invoice inquiries similar in natures and/or scope to user 102's invoice inquiry (e.g., a billing dispute regarding an invoice for a residential account having a due date that falls in the next three days). In some instances, and using any of the example processes described above, allocation engine 124 may allocate user 102's invoice inquiry to that available agent, and additionally or alternatively, may couple the outcome of the applied machine learning algorithms and/or neural networks to further filter the one or more available and capable agents identified using the example processes described above.

Referring back to FIG. 3, computing system 120 may allocate the identified work element (e.g., user 102's invoice inquiry) to one of the agents, e.g., agent 146 of FIG. 1, that is available to resolve the inquiry and possesses primary and/or secondary skills consistent with the inquiry (e.g., in step 308). In some aspects, in step 308, computing system 120 may generate, and store within case record 133, additional data that reflects the allocation of user 102's invoice inquiry to agent 146. Additionally, in further aspects, a workflow engine of computing system 120 (e.g., workflow engine 126) may transmit data that characterizes the user 102's invoice inquiry (e.g., the corresponding inquiry identifier, data identifying user 102, user 102's account, and/or a nature of user 102's inquiry, a due date, a target resolution time, an assigned category and priority, etc.) to a system operated by agent 146 (e.g., agent system 148).

As described above, agent system 148 may present portions of the transmitted data identifying user 102's inquiry, and/or additional data identifying other allocated inquiries and a real-time performance of agent 146, within a corresponding agent dashboard, e.g., graphical user interface (GUI) 150 of FIG. 2C. In some instances, agent 146 may provide input to agent system 148 that selects user 102's invoice inquiry, and based on the selection, and using agent system 148, may apply one or more processes to resolve user 102's invoice inquiry.

In some aspects, agent system 148 may transmit data characterizing the applied resolution processes to computing system 120, based on the transmitted data, workflow engine 126 of computing system 120 may be configured to monitor a performance of agent 146 throughout the resolution processing from initiation to completion (e.g., in step 310). For example, based on the received data, workflow engine 126 may detect the initiation of the resolution processing, may establish a time and/or date (e.g., a time stamp) associated with the initiation of the resolution processing, and may store information associated with the initiated resolution processing within a corresponding portion of a locally accessible data repository, e.g., data repository 130. For example, workflow engine 126 may store data identifying agent 146 and the time stamp associated with the initiation of resolution processing for user 102's invoice inquiry within a data record corresponding to agent 146 within agent database 138.

In some aspects, computing system 120 may receive, from agent system 148, data indicative of a completion of the resolution processing (e.g., in step 312). For example, in step 312, computing system 120 may establish a time stamp associated with the completion of the resolution processing, and may determine a total time, e.g., an actual resolution time, required by agent 146 to resolve the allocated work element, e.g., user 102's invoice inquiry. In additional or alternate examples, computing system 120 may also receive, from agent system 148, data indicative of an outcome of the resolution processing (e.g., an electronic document, email, text message, etc., responsive to user 102's inquiry), and computing system 120 may forward the one or more response documents to client device 110 using any of the example processes described above.

In further aspects, computing system 120 may update stored data records associated with the allocated work element (e.g., user 102's invoice inquiry) and/or the agent (e.g., agent 146) to reflect the completion of the resolution processing (e.g., in step 314). For example, in step 314, computing system 120 may access a stored data record associated with agent 146 (e.g., within agent database 138), and may store the time stamps associated with the initiation and resolution user 102's invoice inquiry and the determined resolution time within the accessed data record, and may deduct the determined resolution time for agent 146's unallocated work time, as described above. In other instances, in step 314, computing system 120 may access and update a stored case record associated with the user 102's invoice inquiry (e.g., case record 133 of case database 132) to reflect the completed resolution processing, and may also store within data repository 130 copies of the one or more response documents, which may be identified within and linked to case record 133 using any of the example processes described above. In response to the completed resolution processing, computing system 120 may also access a stored workflow queue (e.g., workflow queue 134) and delete that entry corresponding to user 102's invoice inquiry (e.g., queue entry 135).

Computing system 120 may also derive one or more known performance indicators (KPIs) for agent 146 based on the determined resolution time, and additionally or alternatively, may update one or more previously derived KPIs (e.g., in step 316). For example, the derived or updated KPIs may include, but are not limited to, the actual resolution time described above, a ratio of the actual resolution time and the target resolution time, agent 146's average resolution time for invoice inquiries, and/or a completion rate of tasks allocated to agent 146. As described above, workflow engine 126 of computing system 120 may store the derived and/or updated KPIs within a portion of data repository 130 associated with agent 146 (e.g., a data record corresponding to agent 146 within agent database 138). Workflow engine 126 may also broadcast portions of the derived and/or updated KPIs (e.g., as KPI data) to agent system 148, systems of other peer agents, and systems operated by managers of agent 146 and/or the peer agents, which may present visual representations of the received KPI data in real-time within a corresponding GUI or agent dashboard.

In certain aspects, the resolution and subsequent removal from the stored workflow queue of user 102's invoice inquiry (and of any additional or alternative number of other customer inquiries) may, over time, result in an imbalanced allocation of customer inquiries across the available and capable agents. For example, as described above, the resolution of user 102's invoice inquiry deducted one hour of unallocated work time from agent 146, who specializes in resolving invoice inquiries involving resolution of residential accounts. In other instances, one or more of the available and capable agents may be unavailable to resolve customer inquiries, which may require a re-allocation of one or more high-priority customer inquiries allocated to these now-unavailable agents. In view of the allocation imbalances, the computing system 120 can perform operations that re-prioritize the queues customer inquiries and to re-allocate these queued customer inquiries to available and capable agents at regular intervals or in response to specific triggering events.

Referring back to FIG. 3, computing system 120 may determine whether to perform one or more of the example processes described above to re-prioritize and re-allocate the queued work elements (e.g., in step 318). In some instances, computing system 120 may be configured to re-prioritize and re-allocate at least a portion of the queued customer inquiries in accordance with a predetermined allocation schedule. For example, the enterprise may establish the predetermined allocation schedule, which may require that computing system 120 re-prioritize and re-allocate the queued work elements at regular intervals, e.g., hourly, daily, or at any additional or alternate temporal interval appropriate to the enterprise, the queued work elements, and computing system 120.

In other instances, computing system 120 may be configured to re-prioritize and re-allocate at least a portion of the queued work elements upon detection of one or more triggering events. Triggering events may include, but are not limited to, a resolution of a predetermined portion (e.g., 25%, 50%, etc.) of the queued work elements within a predetermined time period, a determination that an aggregate amount of available agent work time (e.g., a total amount of work time available across all or a subset of the agents) falls below a predetermined threshold, and/or an unavailability of one or more of the available agents (e.g., a predetermined number or a predetermine portion).

If computing system 120 were to determine to re-prioritize and re-allocate the queued work elements among the available and capable agents (e.g., step 318; YES), example process 300 may pass back to step 302, and computing system 120 may access entries of the stored workflow queue (e.g., within workflow queue 134), may access case records linked to the queued work elements (e.g., within case database 132), and may perform any of the example processes described above to re-prioritize the queued work elements and re-allocate the queued work elements among the available and capable agents. Further, and as described above, computing system 120 may update data records associated with the queued work elements (e.g., corresponding entries within workflow queue 134 and/or corresponding data records within case database 132) to reflect an outcome of the re-prioritization and re-allocation processes. If, however, computing system 120 were to deem unnecessary the re-prioritization and re-allocation of the queued customer inquiries (e.g., step 324; NO), then example process 300 may pass forward to step 320, and example process 300 may be complete.

A computing system 120 may adaptively allocate a customer inquiry, e.g., user 102's invoice inquiry, to an available and capable agent for resolution, and in real-time, may generate and broadcast various metrics indicative of the available and capable agent's performance during a resolution of the allocated customer inquiry. Further, in some implementations, user 102 provides input data specifying the invoice inquiry to a graphical user interface (e.g., customer portal 104) presented client device 110, which packages the provided into work-element data and transmits the work-element data to computing system 120 programmatically through an API. The client device 110 may transmit portions of the work-element data to computing system 120 through any additional or alternate digital communications channel, e.g., by email communications, SMS- or MMS-based text messaging, or instant messaging. Further, in other aspects, computing system 120 may also be configured to receive portions of the work-element data from user 102 via facsimile, via telephone, via U.S. or foreign mail, and via other means of communication.

Further, in some implementations, computing system 120 may be integrated with and/or in communication with one or more customer information systems (CISs) associated with or maintained by the enterprise. In one instance, the CISs may be implemented by one or more processor-based servers or computer systems, as described herein. Further, in certain aspects, computing system 120 may exchange case data (e.g., data records of case database 132) with the CISs at regular intervals or in response to a detection of particular events, e.g., the establishment of case data corresponding to a particular work element and/or a modification of the case data to reflect an agent's initiation and completion of resolution processing for that work element. In some implementations, the exchange of data between computing system 120 and the CISs mat facilitate an automatic integration of cases established by computing system 120 with the CISs, or an automatic integration of cases established by the CISs with case database 132.

Certain implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Further, some implementations of the subject matter described in this specification, including prioritization and categorization engine 122, allocation engine 124, and workflow engine 126, can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, certain implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

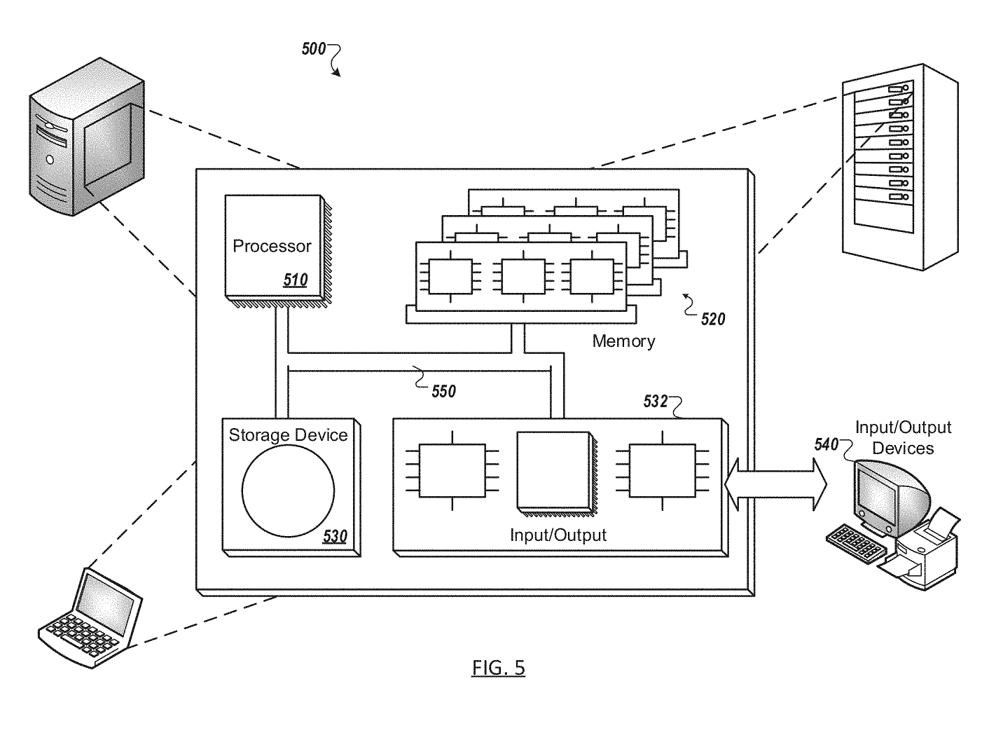

An example of one such type of computer is shown in FIG. 5, which shows a schematic diagram of a generic computer system 500. The system 500 can be used for the operations described in association with any of the computer-implemented methods described previously, according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output module 532 includes hardware or hardware and software for interfacing system 500 with the input/output device 540 or other devices or interfaces.

Further, for situations in which the systems discussed here collect personal information about users, or may make use of personal information, the users may be provided with an opportunity to control whether programs or features collect personal information, e.g., information about a user's social network, social actions or activities, profession, a user's preferences, or a user's current location, or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained, e.g., to a city, zip code, or state level, so that a particular location of a user cannot be determined. Thus, the user may have control over how information is collected about him or her and used by a content server.

While this specification contains many specifics, these should not be construed as limitations, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Thus, particular implementations have been described. Other implementations are within the scope of the following claims. For example, the actions recited in the claims may be performed in a different order and still achieve desirable results.

What is claimed is:

1. A system comprising:
one or more computers and one or more storage devices storing instructions that are operable, when executed by the one or more computers, to cause the one or more computers to perform operations comprising:
obtaining first data identifying a first work element, the first work element being associated with a user and being characterized by a target resolution time;
based on the obtained first data, assigning the first work element to a work category of a plurality of work categories and establishing a priority for resolving the first work element relative to a plurality of other work elements within the assigned work category;
accessing second data identifying a plurality of agents, the agents being associated with corresponding amounts of unallocated time;
based on the second data, identifying one or more of the agents having an amount of unallocated time that exceeds the target resolution time;
determining whether skills sets of a first subset of the identified agents include at least one primary skill associated with the first work element; and
when the skills sets of the first subset of the identified agents are determined to include the at least one primary skill, assigning the first work element to a corresponding one of the identified agents for resolution in accordance with the established priority; and
transmitting information associated with the first work element to a computing system of the corresponding agent, the computing system being configured to present at least a portion of the transmitted information to the corresponding agent through a graphical user interface.

2. The apparatus of claim 1, wherein the step of obtaining comprises:
accessing third data identifying a plurality of queued elements of work, the third data comprising data records corresponding to the queued work elements, the data records identifying characteristics of each of the queued work elements;
establishing that one of the data records corresponds to the first work element; and
obtaining at least a portion of the first data from the corresponding data record, the first data portion comprising at least one of the characteristics of the first work element.

3. The apparatus of claim 1, wherein the step of obtaining comprises receiving at least a portion of the first data from at least one of a device operated by the user or an additional computing system associated with an enterprise.

4. The apparatus of claim 3, wherein the operations further comprise:
storing the first data portion within at least one data record of data repository;
accessing workflow queue data, the workflow queue data comprising a plurality of entries associated with queued work elements;
establishing, within the workflow queue data, an additional entry corresponding to the first work element; and
associating the established additional entry with the at least one data record of the data repository.

5. The apparatus of claim 1, wherein the step of assigning the first work element to the work category comprises:
identifying a plurality of candidate work categories associated with the first work element;
determining that a corresponding one of the candidate work categories is consistent with at least a portion of the first data; and
assigning the first work element to the corresponding one of the candidate work categories.

6. The apparatus of claim 1, wherein the step of assigning the first work element to the work category comprises:
obtaining third data identifying a plurality of second elements of work, the second work elements being assigned to corresponding ones of a plurality work elements;
applying a machine-learning algorithm to at least a portion of the obtained first and third data; and
assigning the first work element to the work category based on an outcome of the applied machine-learning algorithm.

7. The apparatus of claim 1, wherein:
the first data identifies a deadline associated with the first work element; and
the step of establishing comprises establishing the priority for the first work element in accordance with the identified deadline.

8. The apparatus of claim 1, wherein:
the second data comprises, for each of the agents, data identifying an allocated portion of a workday associated with assigned work elements and an unallocated portion of the workday;
the operations further comprise:
accessing the data identifying the allocated and unallocated portions of the workday for the corresponding agent;
determining a time period associated with the resolution of the first work element by the corresponding agent; and
modifying, within the accessed data, the allocated and unallocated portions of the workday of the corresponding agent to reflect the determined time period.

9. The apparatus of claim 1, wherein the operations further comprise:
when the skills sets of the first subset of the identified agents are determined not to include the at least one primary skill, determining whether skill sets of a second subset of the identified agents include at least one secondary skill associated with the first work element; and
when the skills sets of the second subset of the identified agents are determined to include the at least one secondary skill, selecting the corresponding agent from the second subset of the identified agents.

10. The apparatus of claim 9, wherein the operations further comprise:
when the skills sets of the second subset of the identified agents are determined to not include the at least one secondary skill, transmitting an allocation request identifying the first work element to devices associated with the identified agents, the devices being configured to present, through a graphical user interface, one or more interface elements that prompt the identified agents to provide input selecting the first data element for resolution;
receiving data indicating a selection of the first work element by a corresponding one of the identified agents; and
assigning the first work element to the corresponding one of the identified agents for resolution.

11. The apparatus of claim 1, wherein the operations further comprise:
obtaining third data identifying a plurality of resolved work elements, the resolved work elements being allocated to one or more agents, the agents having corresponding skill sets;
applying a machine-learning algorithm to at least a portion of the obtained first and third data; and
assigning the work element to the corresponding agent for resolution based on an outcome of the applied machine-learning algorithm.

12. The apparatus of claim 1, wherein the operations further comprise:
in response to the transmitted information, receiving, from the computer system, third data characterizing a resolution process applied to the first work element by the corresponding agent;
generating, based on at least a portion of the received third data, at least one metric indicative of a performance of the corresponding agent during the applied resolution process; and
transmitting information associated with the one or more generated metrics to the computing system, the computing system being configured to present a graphical representation of the at least one generated metric to the corresponding agent within a portion of the graphical user interface.

13. The apparatus of claim 1, wherein:
the user corresponds to a customer of an enterprise;
the first work element comprises an inquiry received from a device of the user; and
the first data portion comprises at least one of data identifying the customer, data identifying the enterprise, data identifying one or more accounts of the customer, or data characterizing the customer inquiry.

14. The apparatus of claim 13, wherein the operations further comprise:
receiving a response to the inquiry from the computing system, the response being generated by the computing system based on at least one template, and the response comprising an electronic document, an email message, a text message, or textual data;
identifying a communication channel associated with at least one of the user or the received response; and
transmit the received response to the user device using the identified communications channel.

15. The apparatus of claim 1, wherein the step of obtaining comprises:
obtaining message data that includes the first data, the message data comprising at least one of an email message or a text message, the message data having a corresponding message format;
establishing an inconsistency between the message format of the obtained message data and a predetermined message format associated with the first work element; and
in response to the established inconsistency, modifying at least a portion of the obtained message data in accordance with the predetermined data format.

16. A computer-implemented method, comprising:
obtaining, by at least one processor, first data identifying a first work element, the first work element being associated with a user and being characterized by a target resolution time;
based on the obtained first data, assigning, by the at least one processor, the first work element to a work category and establishing a priority for resolving the first work element within the assigned work category;
accessing, by the at least one processor, second data identifying a plurality of agents, the agents being associated with corresponding amounts of unallocated time;
based on the accessed second data, identifying, by the at least one processor, one or more of the agents having an amount of unallocated time that exceeds the target resolution time;
determining, by the at least one processor, whether skills sets of a first subset of the identified agents include at least one primary skill associated with the first work element; and
when the skills sets of the first subset of the identified agents are determined to include the at least one primary skill, assign the first work element to a corresponding one of the identified agents for resolution in accordance with the established priority; and
transmitting, by the at least one processor, information associated with the first work element to a computing system of the corresponding agent, the computing system being configured to present at least a portion of the transmitted information to the corresponding agent through a graphical user interface.

17. An apparatus, comprising:
one or more computers and one or more storage devices storing instructions that are operable, when executed by the one or more computers, to cause the one or more computers to perform operations comprising:
assigning a work element to an agent for resolution, the agent having an amount of unallocated time equivalent to or in excess of a target resolution time of the work element, and the agent having a skill set that includes at least one skill associated with the work element; and
transmitting first data identifying the work element to a computing system of the agent, the computing system being configured to present at least a portion of the transmitted information to the agent through a graphical user interface;
in response to the transmitted data, receiving, from the computer system, second data characterizing a resolution process applied to the work element by the agent;
generating, based on at least a portion of the second data, at least one metric indicative of a performance of the agent during the applied resolution process; and
transmitting third data identifying the at least one generated metric to the computing system, the computing system being configured to present, within a graphical user interface, one or more interface elements that provide a graphical representation of the at least one generated metrics to the agent in real-time.

18. The apparatus of claim 17, wherein the operations further comprise:
based on at least an additional portion of the second data, updating the at least one generated metric to reflect the performance of the agent during the resolution process; and
transmitting fourth data identifying the at least one modified metric to the computing system, the computing system being configured to modify at least one of the presented interface elements to reflect the at least one updated metric in real-time.

19. The apparatus of claim 17, wherein:
the third data comprises first and second time stamps, the first time stamp corresponding to an initiation of the resolution process, and the second time stamp corresponding to a completion of the resolution process; and
the operations further comprise determining an actual resolution time for the first work element based on a difference between the first and second time stamps;
the at least one metric comprises the actual resolution time.

20. The apparatus of claim 17, wherein the operations further comprise transmitting the third data to at least one of a computing system associated with a manager of the agent or a computing system associated with at least one additional agent.
